(19) United States
(12) Patent Application Publication
(10) Pub. No.: US 2023/0369761 A1
(43) Pub. Date: Nov. 16, 2023

(54) ANTENNA UNIT

(71) Applicant: NIPPON PILLAR PACKING CO., LTD., Osaka (JP)

(72) Inventors: Takeshi OKUNAGA, Osaka-shi (JP); Yusuke NATSUHARA, Osaka-shi (JP)

(73) Assignee: NIPPON PILLAR PACKING CO., LTD., Osaka (JP)

(21) Appl. No.: 18/195,739

(22) Filed: May 10, 2023

(30) Foreign Application Priority Data
May 11, 2022 (JP) 2022-078263

(51) Int. Cl. H01Q 3/44; H01Q 9/04

(52) U.S. Cl. CPC H01Q 3/44; H01Q 9/0407

(57) ABSTRACT

Provided is an antenna unit capable of suitably increasing a 3 dB beamwidth. An antenna unit includes a single feed antenna provided on a dielectric body, and a pair of parasitic antennas provided on one side and another side of the single feed antenna in the dielectric body, and the feed antenna includes a feed line, and a feed body portion including a radiation element supplied with power through the feed line, the pair of parasitic antennas each include a parasitic body portion that has substantially the same shape as the feed body portion, pitches between the feed antenna and the pair of parasitic antennas are substantially equal to each other, and the pitches are each within a range from 0.4λ+{(λ/2)×n} to 0.6λ+{(λ/2)×n} inclusive, where λ denotes a free space wavelength (n is an integer that is 0 or more).

### CROSS REFERENCE TO RELATED APPLICATIONS

This application claims priority to Japanese Patent Application No. 2022-078263 filed on May 11, 2022, the entire contents of which are incorporated herein by reference.

### TECHNICAL FIELD

The present invention relates to an antenna unit.

### BACKGROUND ART

JP 6456716 discloses one example of an antenna unit. This antenna unit includes a plurality of feed antennas provided on a dielectric body, and parasitic antennas provided on both sides of the plurality of feed antennas.

JP 6456716 is an example of related art.

### SUMMARY OF THE INVENTION

In the above antenna unit, no consideration is given to increasing an angular beamwidth of a range between the points where the gain falls to 3 dB lower than the maximum gain of the main lobe, or in other words, a 3 dB beamwidth. For this reason, there is room for improvement in terms of increasing the 3 dB beamwidth.

An object of the present invention is to provide an antenna unit capable of suitably increasing the 3 dB beamwidth.

An antenna unit according to a first aspect of the present invention includes a single feed antenna provided on a dielectric body, and a pair of parasitic antennas provided on one side and another side of the single feed antenna in the dielectric body, wherein the feed antenna includes a feed line, and a feed body portion including a radiation element supplied with power through the feed line, the pair of parasitic antennas each include a parasitic body portion that has substantially the same shape as the feed body portion, pitches between the feed antenna and the pair of parasitic antennas are substantially equal to each other, and the pitches are each within a range from 0.4λ+{(λ/2)×n} to 0.6λ+{(λ/2)×n} inclusive (n is an integer that is 0 or more), where λ denotes a free space wavelength.

When the above antenna unit is used for transmission, for example, radio waves radiated from the single feed antenna propagate to the pair of parasitic antennas. The pair of parasitic antennas radiate radio waves with a different phase from those radiated from the single feed antenna. At the front (0°) in the horizontal angle, there is a phase difference between radio waves radiated from the single feed antenna and radio waves radiated from the pair of parasitic antennas, and therefore the gain of the beamwidth is lower than that of a conventional antenna unit that has only a feed antenna. On the other hand, in an oblique direction in the horizontal angle, e.g., 45°, the radio waves radiated from the single feed antenna and the radio waves radiated from the pair of parasitic antennas are synthesized, and therefore the gain of the beamwidth is greater than that of a conventional antenna unit that has only a feed antenna. The inventor(s) of the present application found that the 3 dB beamwidth is suitably increased by setting the pitches between the feed antenna and the pair of parasitic antennas equal to each other and setting the pitches within the above range.

The antenna unit according to a second aspect of the present invention is the antenna unit according to the first aspect, in which the single feed antenna is a horizontal polarized antenna, and the pitches are each 2λ or less.

It was confirmed that, when the feed antenna is a horizontal polarized antenna, the 3 dB beamwidth is suitably increased by setting the pitches to 2λ or less.

The antenna unit according to a third aspect of the present invention is the antenna unit according to the first aspect, in which the single feed antenna is a vertical polarized antenna, and the pitches are each 1λ or less.

It was confirmed that, when the feed antenna is a vertical polarized antenna, the 3 dB beamwidth is suitably increased by setting the pitches to 1λ or less.

The antenna unit according to a fourth aspect of the present invention includes a single feed antenna provided on a dielectric body, and a pair of parasitic antennas provided on one side and another side of the single feed antenna in the dielectric body, in which the feed antenna includes a feed line, and a feed body portion including a radiation element supplied with power through the feed line, the pair of parasitic antennas include a first parasitic antenna provided on one side of the single feed antenna, and a second parasitic antenna provided on another side of the single feed antenna, the first parasitic antenna and the second parasitic antenna each include a parasitic body portion that has substantially the same shape as the feed body portion, and a phase adjustment line extending from an end portion of the parasitic body portion, the single feed antenna is a horizontal polarized antenna, and a sum of a first pitch and a first length and a sum of a second pitch and a second length are each within a range from 0.75λe+{(λ/2)×n} to 1.05λe+{(λ/2)n} inclusive (note that n is an integer that is 0 or more), where λ denotes a free space wavelength, λg denotes a wavelength inside a dielectric body, λe denotes a sum of λ and λg, the first pitch is a pitch between the feed antenna and the first parasitic antenna, the second pitch is a pitch between the feed antenna and the second parasitic antenna, the first length is a length of the phase adjustment line of the first parasitic antenna, and the second length is a length of the phase adjustment line of the second parasitic antenna.

According to the above antenna unit, an effect similar to the effect achieved by the antenna unit of the first aspect is achieved. Further, according to the above antenna unit, the amplitude of re-radiated radio waves can be adjusted by adjusting the pitches between the single feed antenna and the pair of parasitic antennas. Also, the phase of the re-radiated radio waves can be adjusted by adjusting the length of the phase adjustment line of the pair of parasitic antennas. For this reason, even if the pitches between the single feed antenna and the pair of parasitic antennas cannot be sufficiently ensured due to lack of installation space or the like, the directivity of the radio waves can be suitably adjusted. Also, according to the antenna unit, it was confirmed that the 3 dB beamwidth is suitably increased.

The antenna unit according to a fifth aspect of the present invention includes a single feed antenna provided on a dielectric body, and a pair of parasitic antennas provided on one side and another side of the single feed antenna in the dielectric body, in which the feed antenna includes a feed line, and a feed body portion including a radiation element supplied with power through the feed line, the pair of parasitic antennas include a first parasitic antenna provided on one side of the single feed antenna and a second parasitic antenna provided on the other side of the single feed antenna, the first parasitic antenna and the second parasitic antenna each include a parasitic body portion that has substantially the same shape as the feed body portion and a phase adjustment line extending from an end portion of the parasitic body portion, the single feed antenna is a vertical polarized antenna, and a sum of a first pitch and a first length and a sum of a second pitch and a second length are each within a range from 0.35λe+{(λ/2)×n} to 0.7λe+{(λ/2)n} inclusive (note that n is an integer that is 0 or more), where λ denotes a free space wavelength, λg denotes a wavelength inside a dielectric body, λe denotes a sum of λ and λg, the first pitch is a pitch between the feed antenna and the first parasitic antenna, the second pitch is a pitch between the feed antenna and the second parasitic antenna, the first length is a length of the phase adjustment line of the first parasitic antenna, and the second length is a pitch between the feed antenna and the second parasitic antenna.

According to the above antenna unit, an effect similar to that achieved by the antenna unit of the fourth aspect can be achieved.

The antenna unit according to a fifth aspect of the present invention is the antenna unit according to the aspect 4 or 5, in which the first pitch is different from the second pitch, the first length is different from the second length, a sum of the first pitch and the first length and a sum of the second pitch and the second length are substantially equal to each other.

It was confirmed that, according to the above antenna unit, the 3 dB beamwidth is suitably increased.

According to the antenna unit according to the present invention, the 3 dB beamwidth can be suitably increased.

### BRIEF DESCRIPTION OF THE DRAWINGS

FIG. 1 is a plan view of an antenna unit of a first embodiment.

FIG. 2 is a cross sectional view taken along line D2-D2 in FIG. 1.

FIG. 3 is a cross sectional view showing a state where propagation occurs from a feed antenna in FIG. 2 to parasitic antennas.

FIG. 4 is a cross sectional view showing a state where the parasitic antennas in FIG. 3 radiate radio waves.

FIG. 5 is a cross sectional view showing a state where radio waves radiated from the feed antenna and radio waves radiated from the parasitic antennas in FIG. 4 are synthesized.

FIG. 6 shows a result of simulation related to a directivity of the antenna unit of the first embodiment.

FIG. 7 shows a result of simulation related to a directivity of an antenna unit of a variation of the first embodiment.

FIG. 8 is a plan view of an antenna unit of a second embodiment.

FIG. 9 shows a result of simulation related to a directivity of the antenna unit of the second embodiment.

FIG. 10 is a plan view of an antenna unit of a third embodiment.

FIG. 11 shows a result of simulation related to a directivity of the antenna unit of a variation of the third embodiment.

FIG. 12 is a result of simulation related to a directivity of an antenna unit of a variation of the third embodiment.

FIG. 13 is a plan view of an antenna unit of a variation.

FIG. 14 is a plan view of an antenna unit of another variation.

### EMBODIMENTS OF THE INVENTION

Hereinafter, embodiments of the present invention will be described in detail with reference to the drawings. Note that the same or equivalent parts in the drawings are given the same reference signs and redundant description thereof is omitted.

### 1. First Embodiment

### 1-1. Overall Configuration of Antenna Unit

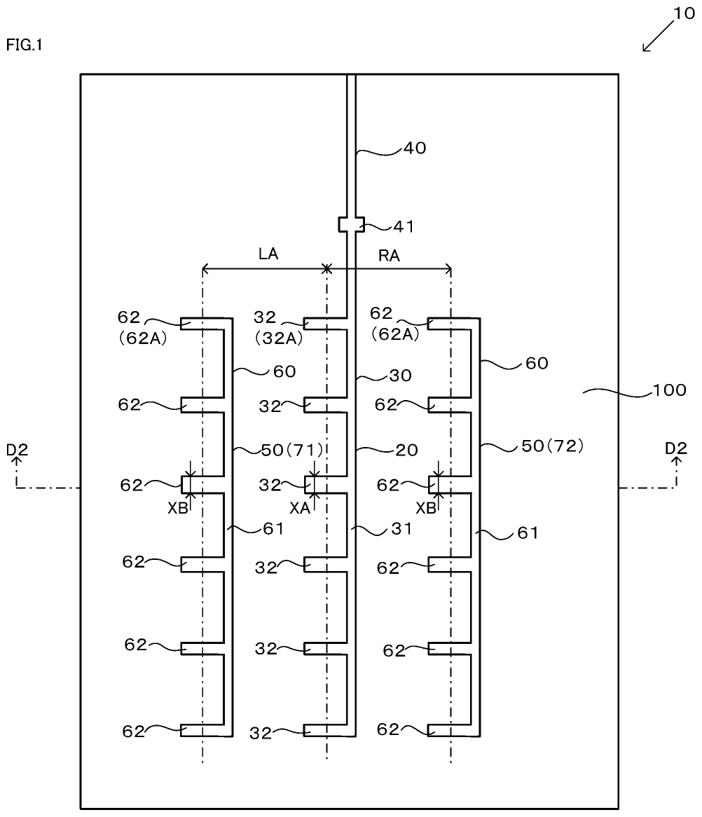

FIG. 1 is a plan view of an antenna unit 10 of the present embodiment. The antenna unit 10 is a transmission antenna unit for transmitting radio waves to a reception antenna (not shown), for example. The antenna unit 10 may also be a reception antenna unit. The antenna unit 10 includes a single feed antenna 20 and a pair of parasitic antennas 50. The single feed antenna 20 and the pair of parasitic antennas 50 are arranged side by side within a surface of a dielectric body 100. The dielectric body 100 has a plate-like shape, and is constituted by a material such as epoxy resin, glass, or Teflon (registered trademark). A metal foil 110, which serves as the ground, is joined to a surface of the dielectric body 100 opposite to the surface on which the single feed antenna 20 and the pair of parasitic antennas 50 are provided. The metal foil 110 is a copper foil, for example. Hereinafter, in a plan view of the antenna unit 10, the direction in which the single feed antenna 20 and the pair of parasitic antennas 50 extend is denoted as the longitudinal direction, and the direction orthogonal to the longitudinal direction in a plan view is denoted as the width direction.

In the present embodiment, the single feed antenna 20 (hereinafter referred to as simply “feed antenna 20”) is a horizontal polarized antenna. The feed antenna 20 may also be a vertical polarized antenna. The feed antenna 20 is a micro strip antenna, for example. The feed antenna 20 includes a feed body portion 30 and a stub 40.

The feed body portion 30 includes a feed line 31 and radiation elements 32 that are supplied with power through the feed line 31. One end of the feed line 31 is connected to a converter (not shown) provided at the end of a waveguide via the stub 40, for example. The converter performs power conversion between the waveguide and the stub 40. The converter serves as a point of feeding to the feed line 31 via the stub 40. The feed line 31 is, for example, a planar line, and is a conductive thin film formed on the dielectric body 100.

The radiation elements 32 are linked to the feed line 31 and protrude to one side in the width direction from the feed line 31. The radiation elements 32 are planar antennas, for example, and are conductive thin films formed on the dielectric body 100. The number of the radiation elements 32 included in the feed body portion 30 can be freely selected. In the present embodiment, the feed body portion 30 includes six radiation elements. The feed body portion 30 may include 1 to 5, or 7 or more radiation elements. In the present embodiment, a length XA in the longitudinal direction of each of the six radiation elements 32 is longer the closer the radiation element 32 is to the center in the longitudinal direction of the feed antenna 20.

In the feed antenna 20, the feed line 31 is a line extending to the radiation element 32A that is closest to the feeding side. In the present embodiment, the feed body portion 30 is a part including the feed line 31 and the six radiation elements 32.

The stub 40 extends from an end portion of the feed body portion 30. The stub 40 is a conductive thin film formed on the dielectric body 100, for example. A matching pattern 41 for suppressing reflection of radio waves is formed at the middle portion of the stub 40.

A pair of parasitic antennas 50 include a first parasitic antenna 71 provided on one side in the width direction of the feed antenna 20 and a second antenna 72 provided on the other side of the feed antenna 20. The first parasitic antenna 71 and the second parasitic antenna 72 have similar configurations. Hereinafter, when the first parasitic antenna 71 and the second parasitic antenna 72 are not particularly distinguished, they may be simply called “parasitic antennas 50”.

Unlike the feed antenna 20, the parasitic antennas 50 are not connected to the converter. For this reason, power is not supplied to the parasitic antennas 50. The parasitic antennas 50 each include a parasitic body portion 60 that has substantially the same shape as the feed body portion 30. Each parasitic body portion 60 includes a parasitic line 61 and radiation elements 62 linked to the parasitic line 61. The parasitic lines 61 are, for example, planar lines, and are conductive thin films formed on the dielectric body 100.

The radiation elements 62 protrude toward one side in the width direction from the parasitic lines 61. The radiation elements 62 are, for example, planar antennas, and are conductive thin films formed on the dielectric body 100. The number of the radiation elements 62 included in the parasitic body portion 60 can be freely selected. In the present embodiment, the parasitic body portion 60 includes six radiation elements. The parasitic body portion 60 may also include 1 to 5, or 7 or more radiation elements. In the present embodiment, a length XB in the longitudinal direction of each of the six radiation elements 62 is longer the closer the radiation element 62 is to the center in the longitudinal direction of the parasitic antennas 50. In the present embodiment, the parasitic body portion 60 is a part including the parasitic line 61 and six radiation elements 62.

In the present embodiment, a pitch LA in the width direction between the feed antenna 20 and the first parasitic antenna 71 is substantially equal to a pitch RA between the feed antenna 20 and the second parasitic antenna 72. Further, in the present embodiment, from a viewpoint of suitably increasing the 3 dB beamwidth, the pitches LA and RA are each within the range from 0.4λ+{(λ/2)×n} to 0.6λ+{(λ/2)×n} inclusive, where λ denotes a free space wavelength. Note that n is an integer that is 0 or more. In particular, when the isolation is 50 dB or less, since the strength of radio waves that propagate from the feed antenna 20 to the pair of parasitic antennas 50 is high, the 3 dB beamwidth can be more suitably increased. In order to set the isolation to 50 dB or less, when the feed antenna 20 is a horizontal polarized antenna, the pitches LA and RA are each preferably 2λ or less, and when the feed antenna 20 is a vertical polarized antenna, the pitches LA and RA are each preferably 1λ or less. Note that the free space wavelength is 12.49 mm at 24 GHz, for example.

### 1-2. Operation and Effects of Antenna Unit

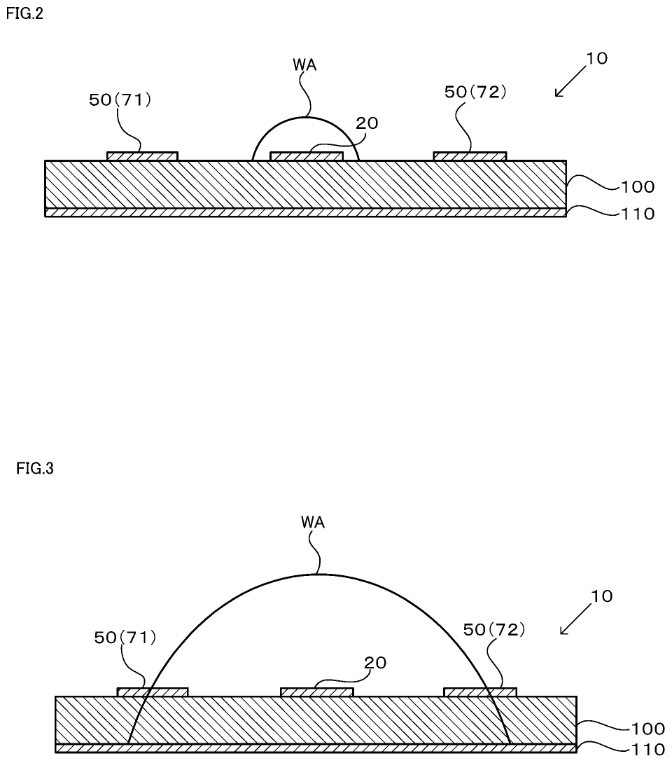

The operation and effects of the antenna unit 10 will be described below with reference to FIGS. 2 to 5. FIGS. 2 to 5 are cross-sectional views taken along line D2-D2 in FIG. 1.

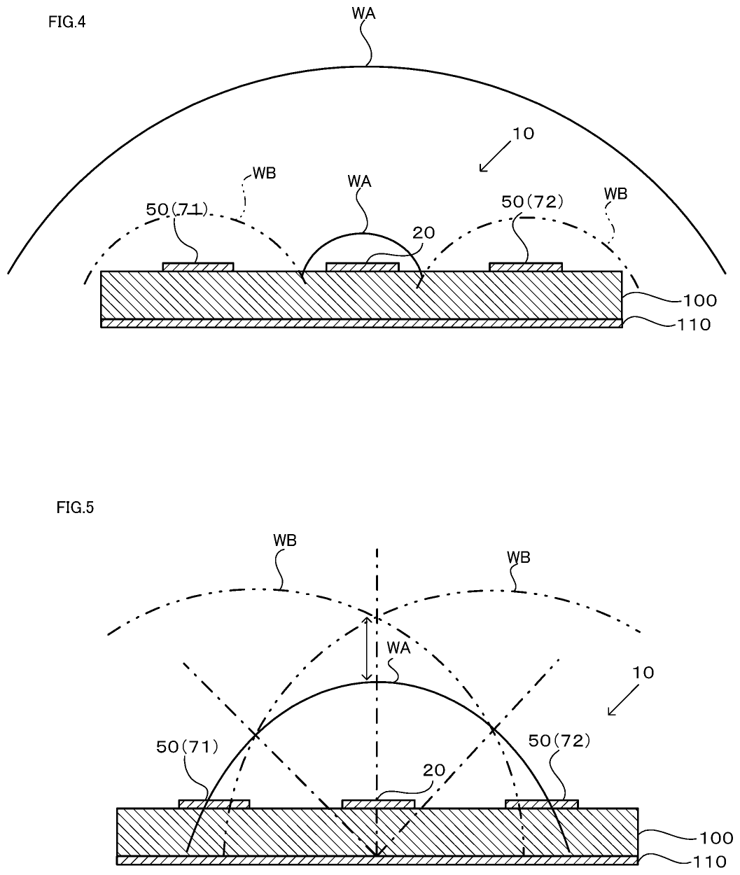

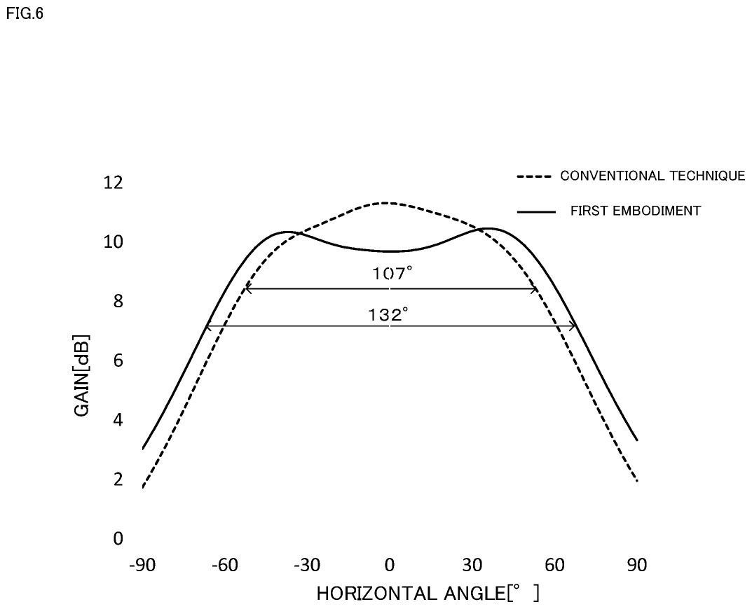

As shown in FIG. 2, the feed antenna 20 radiates radio waves WA. As shown in FIG. 3, the radio waves WA propagate to the pair of parasitic antennas 71 and 72. As shown in FIG. 4, the pair of parasitic antennas 71 and 72 radiate radio waves WB with a different phase from the radio waves WA radiated from the feed antenna 20. As shown by the bidirectional arrow in FIG. 5, at the front (0°) in the horizontal angle, there is a phase difference between the radio waves WA radiated from the feed antenna 20 and the radio waves WB radiated from the pair of parasitic antennas 71 and 72, and therefore the gain of the beamwidth is lower than that of the conventional antenna unit that has only the feed antenna. On the other hand, in an oblique direction of the horizontal angle, for example, 45°, the radio waves WA radiated from the feed antenna 20 and the radio waves WB radiated from the pair of parasitic antennas 71 and 72 are synthesized, and therefore the gain of the beamwidth is greater than that of the antenna unit that has only a feed antenna. The inventor(s) of the present application found that the 3 dB beamwidth is suitably increased by setting the pitches LA and RA of the feed antenna 20 and the pair of parasitic antennas 71 and 72 such that they are equal to each other and fall within a predetermined range.

### 1-3. Result of Simulation of Antenna unit

FIG. 6 shows the result of simulation regarding the directivity of a conventional antenna unit that has only a feed antenna, and the antenna unit 10 of the present embodiment. The 3 dB beamwidth of the antenna unit 10 of the present embodiment is 132°. The 3 dB beamwidth of the conventional antenna unit is 107°. Accordingly, it was confirmed that the antenna unit 10 of the present embodiment can increase the 3 dB beamwidth by 23.4% compared with the conventional antenna unit.

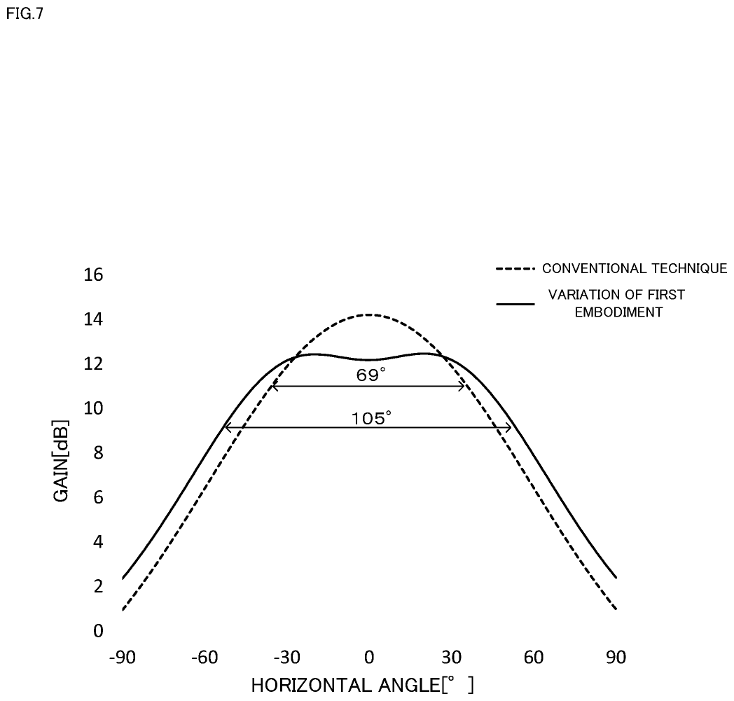

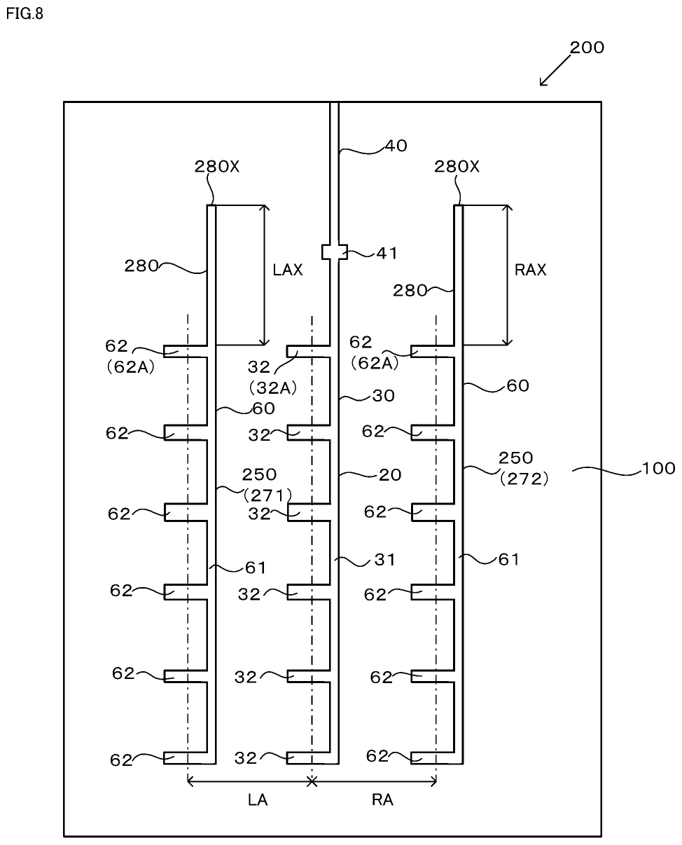

FIG. 7 shows the result of simulation regarding the regarding the directivity of a conventional antenna unit that has only a feed antenna, and the antenna unit 10 of the present embodiment. In the example shown in FIG. 7, the feed antenna 20 of the antenna unit 10 of the variation is a vertical polarized antenna. The 3 dB beamwidth of the antenna unit 10 of the variation is 105°. The 3 dB beamwidth of the conventional antenna unit is 69°. Accordingly, it was confirmed that the antenna unit 10 of the variation can increase the 3 dB beamwidth by 52.2% compared with the conventional antenna unit.

### 2. Second Embodiment

The configuration of an antenna unit 200 of a second embodiment is different from the first embodiment in that a pair of parasitic antennas 250 are provided, and other configurations are similar to that of the first embodiment. Hereinafter, the antenna unit 200 of the second embodiment will be described focusing on the difference from the first embodiment.

### 2-1. Overall Configuration of Antenna Unit

FIG. 8 is a plan view of the antenna unit 200 of the second embodiment. The antenna unit 200 includes the pair of parasitic antennas 250. The pair of parasitic antennas 250 include a first parasitic antenna 271 provided on one side in the width direction of the feed antenna 20 and a second parasitic antenna 272 provided on the other side of the feed antenna 20. The first parasitic antenna 271 and the second parasitic antenna 272 have similar configurations. Hereinafter, when the first parasitic antenna 271 and the second parasitic antenna 272 are not particularly distinguished, they may be simply called “parasitic antennas 250”.

The parasitic antennas 250 each include a parasitic body portion 60 and a phase adjustment line 280. Each phase adjustment line 280 extends from an end portion of the parasitic body portion 60. The phase adjustment lines 280 are conductive thin films formed on the dielectric body 100, for example. In the present embodiment, an end 280X of each phase adjustment line 280 is open.

In the present embodiment, a length LAX of the phase adjustment line 280 of the first parasitic antenna 271 and a length RAX of the phase adjustment line 280 of the second parasitic antenna 272 are equal to each other. Similarly to the first embodiment, the pitches LA and RA are equal to each other. Accordingly, a sum SL of the pitch LA and the length LAX and a sum SR of the pitch RA and the length RAX are equal to each other.

### 2-2. Effects of Antenna Unit

According to the antenna unit 200 of the present embodiment, an effect similar to that of the antenna unit 10 of the first embodiment can be achieved. Further, in the antenna unit 200, the amplitude of the re-radiated radio waves can be adjusted by adjusting the pitches LA and RA between the feed antenna 20 and the pair of parasitic antennas 250. Also, the phase of the re-radiated radio waves can be adjusted by adjusting the lengths LAX and RAX of the phase adjustment lines 280 of the pair of parasitic antennas 250. For this reason, even if the pitches LA and RA between the feed antenna 20 and the pair of parasitic antennas 250 cannot be sufficiently ensured due to lack of installation space or the like, the directivity can be suitably adjusted.

### 2-3. Result of Simulation of Antenna Unit

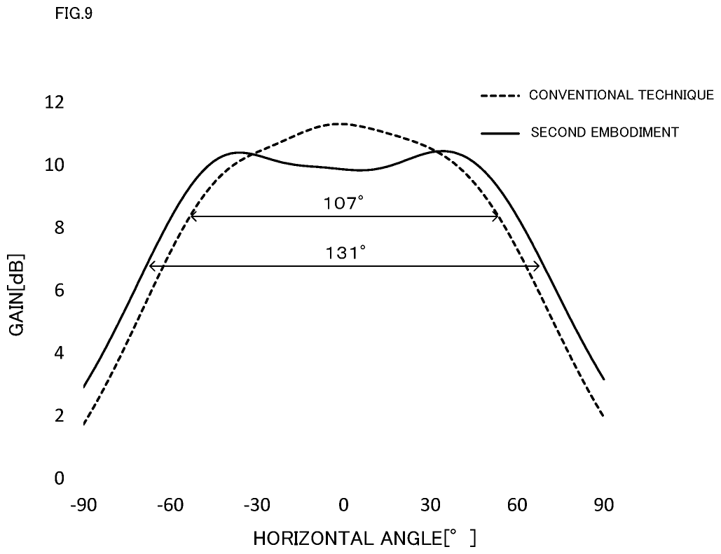

FIG. 9 shows the result of simulation regarding the directivity of a conventional antenna unit that has only a feed antenna and the antenna unit 200 of the present embodiment. The 3 dB beamwidth of the antenna unit 200 of the present embodiment is 131°. The 3 dB beamwidth of the conventional antenna unit is 107°. Accordingly, it was confirmed that the antenna unit 200 of the present embodiment can increase the 3 dB beamwidth by 22.4% compared with the conventional antenna unit.

### 3. Third Embodiment

The configuration of an antenna unit 300 of a third embodiment is different from the second embodiment in that a pair of parasitic antennas 350 are provided, and other configurations are similar to that of the second embodiment. Hereinafter, the antenna unit 300 of the third embodiment will be described focusing on the difference from the second embodiment.

### 3-1. Overall Configuration of Antenna Unit

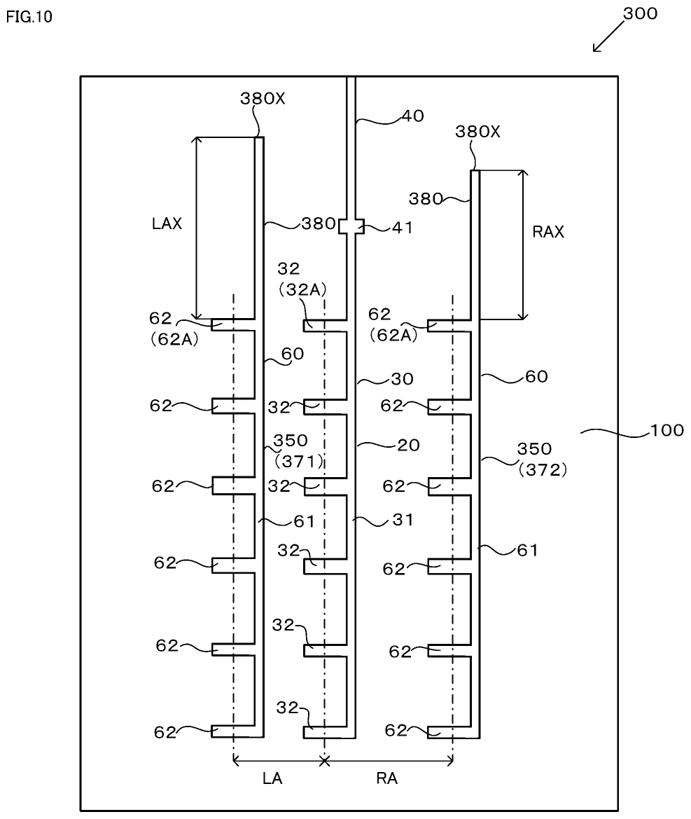

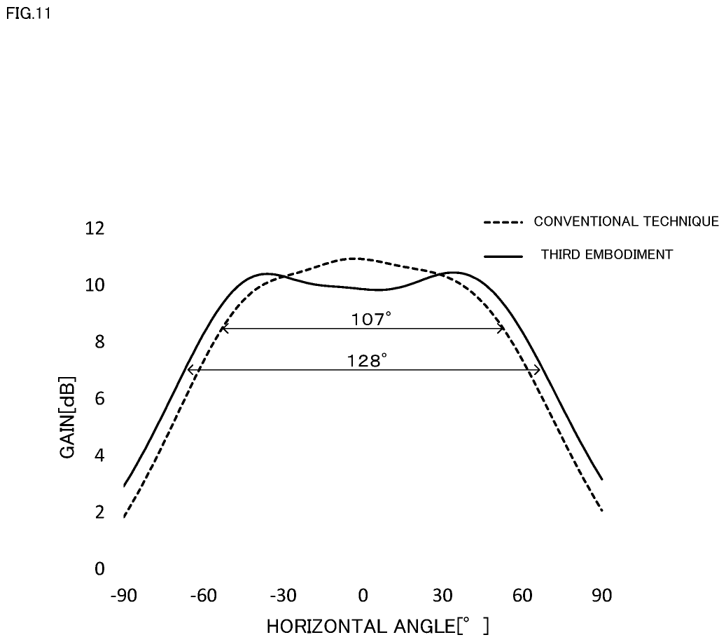

FIG. 10 is a plan view of the antenna unit 300 of the third embodiment. The antenna unit 300 includes the pair of parasitic antennas 350. The pair of parasitic antennas 350 includes a first parasitic antenna 371 provided on one side in the width direction of the feed antenna 20 and a second parasitic antenna 372 provided on the other side of the feed antenna 20. Hereinafter, when the first parasitic antenna 371 and the second parasitic antenna 372 are not particularly distinguished, they may be simply called “parasitic antennas 350”.

The parasitic antennas 350 each include a parasitic body portion 60 and a phase adjustment line 380. Each phase adjustment line 380 extends from an end portion of the parasitic body portion 60. The phase adjustment lines 380 are conductive thin films formed on the dielectric body 100, for example. In the present embodiment, an end 380X of each phase adjustment line 380 is open.

In the present embodiment, a length LAX of the phase adjustment line 380 of the first parasitic antenna 371 is different from a length RAX of the phase adjustment line 380 of the second parasitic antenna 372. In the present embodiment, the length LAX is longer than the length RAX. In the present embodiment, a pitch LA is different from a pitch RA. In the present embodiment, the pitch LA is shorter than the pitch RA. In the present embodiment, a sum SL of the pitch LA and the length LAX is preferably equal to a sum SR of the pitch RA and the length RAX.

As shown in FIG. 10, when the feed antenna 20 is a horizontal polarized antenna, from a viewpoint of suitably increasing the 3 dB beamwidth, the sum of λ and λg is λe, the sum SL and the sum SR are within the range from 0.75λe+{(λ/2)×n} to 1.05λe+{(λ/2)×n} inclusive, where λ denotes a free space wavelength, and λg denotes the wavelength within the dielectric body 100. Note that n is an integer that is 0 or more. Note that the wavelength within the dielectric body 100 is 7.95 mm at 24 GHz, for example.

When the feed antenna 20 is a vertical polarized antenna, from a viewpoint of suitably increasing the 3 dB beamwidth, the sum SL and the sum SR are within the range from 0.35λe+{(λ/2)×n} to 0.7λe+{(λ/2)×n} inclusive, where λ denotes the free space wavelength, λg denotes the wavelength within the dielectric body 100, and λe denotes the sum of λ and λg. Note that n is an integer that is 0 or more.

### 3-2. Result of Simulation of Antenna Unit

FIG. 11 shows the result of simulation regarding the directivity of a conventional antenna unit that has a feed antenna, and the antenna unit 300 of the present embodiment. The 3 dB beamwidth of the antenna unit 300 of the present embodiment is 128°. The 3 dB beamwidth of the conventional antenna unit is 107°. Accordingly, it was confirmed that the antenna unit 300 of the present embodiment can increase the 3 dB beamwidth by 19.6% compared with the conventional antenna unit.

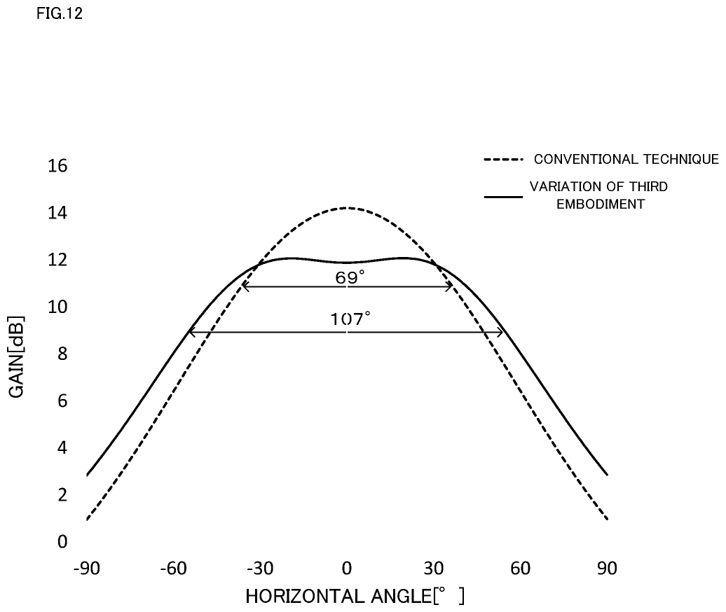

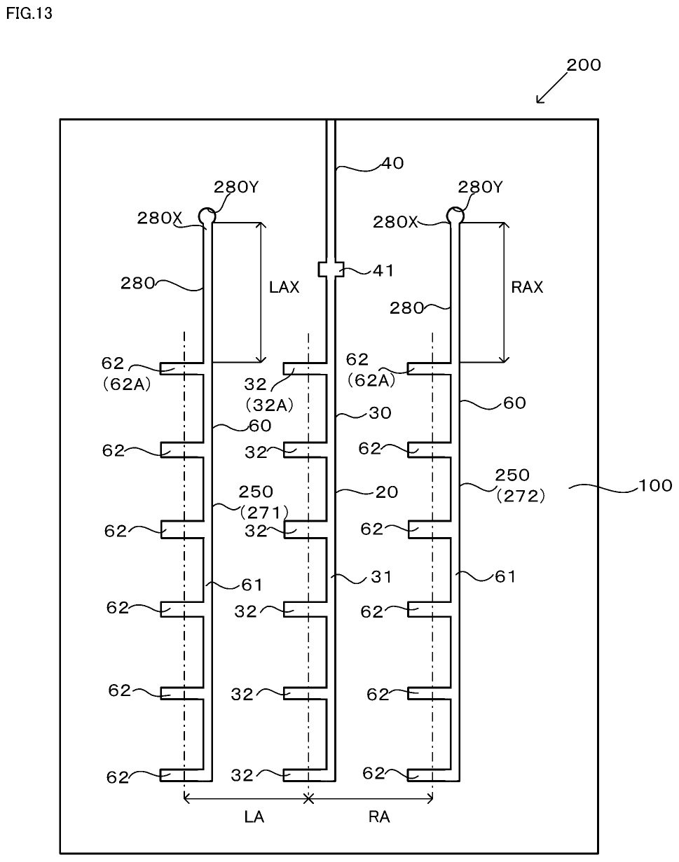

FIG. 12 shows the result of simulation regarding the directivity of a conventional antenna unit that has only a feed antenna and the antenna unit 300 of the present embodiment. In the example shown in FIG. 12, the feed antenna 20 of the antenna unit 300 of the variation is a vertical polarized antenna. The 3 dB beamwidth of the antenna unit 300 of the variation is 107°. The 3 dB beamwidth of the conventional antenna unit is 69°. Accordingly, it was confirmed that the antenna unit 300 of the variation can increase the 3 dB beamwidth by 55.1% compared with the conventional antenna unit.

### 4. Variations

The above embodiments are examples of modes which may be adopted to the antenna unit according to the present invention, and are not intended to limit the modes. The antenna unit according to the present invention may adopt modes different from those exemplified in the embodiments. One example of those is a mode in which part of the configuration of any of the embodiments is replaced, modified, or omitted, or a new configuration is added to the above embodiments. Examples of the variations of the embodiments will be described below. Note that the above embodiments and the following variations can be combined with each other as long as no technical contradiction arises.

### 4-1

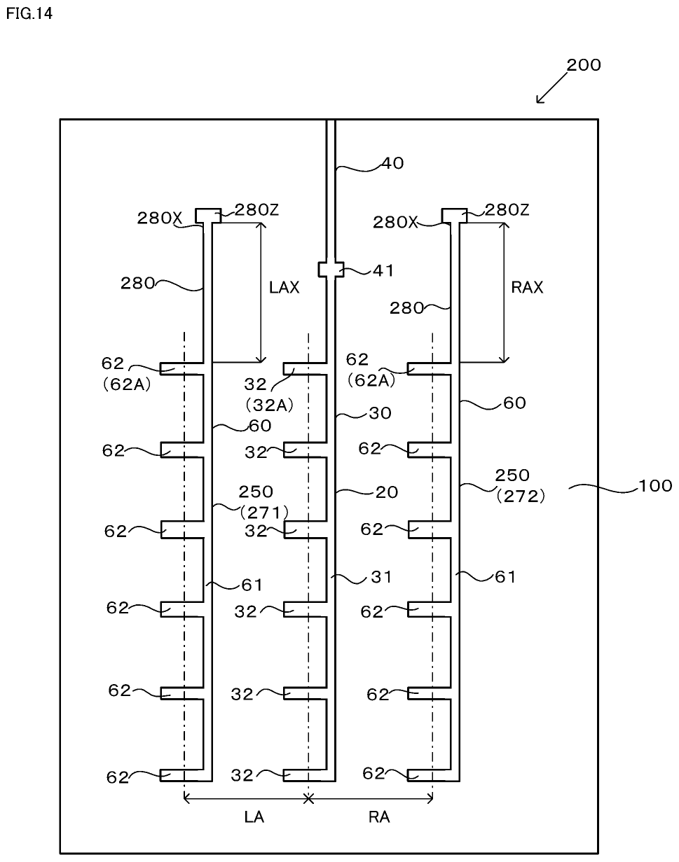

In the second embodiment, the ends 280X of the phase adjustment lines 280 of the parasitic antennas 250 can be freely changed. As shown in FIG. 13, for example, a configuration may also be adopted in which through holes 280Y are formed in the ends 280X of the phase adjustment lines 280 to connect the ends 280X to the ground. As shown in FIG. 14, for example, a configuration may be also adopted in which resistors 280Z or the like are arranged at the ends 280X of the phase adjustment lines 280 to prevent reflection of radio waves. In the example shown in FIG. 14, it is preferable that the timing of re-radiation is adjusted by adjusting the pitches LA and RA. These variations may also be adopted to the antenna unit 300 of the third embodiment.

### 4-2

In the third embodiment, a configuration may also be adopted in which the length LAX is shorter than the length RAX and the pitch LA is longer than the pitch RA. In this variation, the sum SL is preferably equal to the sum SR.

### List of Reference Numerals

10, 200, 300 Antenna unit
20 Feed antenna
30 Feed body portion
31 Feed line
32 Radiation element
50, 250, 350 Parasitic antenna
60 Feed body portion
61 Feed line
62 Radiation element
71, 271, 371 First parasitic antenna
72, 272, 372 Second parasitic antenna
100 Dielectric body
280, 380 Phase adjustment line

What is claimed is:

1. An antenna unit comprising:
a single feed antenna provided on a dielectric body, and
a pair of parasitic antennas provided on one side and another side of the single feed antenna in the dielectric body,
wherein the feed antenna includes a feed line, and a feed body portion including a radiation element supplied with power through the feed line,
the pair of parasitic antennas each include a parasitic body portion that has substantially the same shape as the feed body portion,
pitches between the feed antenna and the pair of parasitic antennas are substantially equal to each other, and
the pitches are each within a range from 0.4λ+{(λ/2)×n} to 0.6λ+{(λ/2)×n} inclusive (n is an integer that is 0 or more), where λ denotes a free space wavelength.

2. The antenna unit according to claim 1,
wherein the single feed antenna is a horizontal polarized antenna, and
the pitches are each 2λ or less.

3. The antenna unit according to claim 1,
wherein the single feed antenna is a vertical polarized antenna, and
the pitches are each 1λ or less.

4. An antenna unit comprising:
a single feed antenna provided on a dielectric body, and
a pair of parasitic antennas provided on one side and another side of the single feed antenna in the dielectric body,
wherein the feed antenna includes a feed line, and a feed body portion including a radiation element supplied with power through the feed line,
the pair of parasitic antennas include a first parasitic antenna provided on one side of the single feed antenna, and a second parasitic antenna provided on another side of the single feed antenna,
the first parasitic antenna and the second parasitic antenna each include a parasitic body portion that has substantially the same shape as the feed body portion, and a phase adjustment line extending from an end portion of the parasitic body portion,
the single feed antenna is a horizontal polarized antenna, and
a sum of a first pitch and a first length and a sum of a second pitch and a second length are each within a range from 0.75λe+{(λ/2)×n} to 1.05λe+{(λ/2)n} inclusive (note that n is an integer that is 0 or more),
where λ denotes a free space wavelength, λg denotes a wavelength inside a dielectric body, λe denotes a sum of λ and λg,
the first pitch is a pitch between the feed antenna and the first parasitic antenna,
the second pitch is a pitch between the feed antenna and the second parasitic antenna,
the first length is a length of the phase adjustment line of the first parasitic antenna, and
the second length is a length of the phase adjustment line of the second parasitic antenna.

5. An antenna unit comprising:
a single feed antenna provided on a dielectric body; and
a pair of parasitic antennas provided on one side and another side of the single feed antenna in the dielectric body,
wherein the feed antenna includes a feed line, and a feed body portion including a radiation element supplied with power through the feed line,
the pair of parasitic antennas include a first parasitic antenna provided on one side of the single feed antenna and a second parasitic antenna provided on the other side of the single feed antenna,
the first parasitic antenna and the second parasitic antenna each include a parasitic body portion that has substantially the same shape as the feed body portion and a phase adjustment line extending from an end portion of the parasitic body portion,
the single feed antenna is a vertical polarized antenna, and
a sum of a first pitch and a first length and a sum of a second pitch and a second length are each within a range from 0.35λe+{(λ/2)×n} to 0.7λe+{(λ/2)n} inclusive (note that n is an integer that is 0 or more),
where λ denotes a free space wavelength, λg denotes a wavelength inside a dielectric body, λe denotes a sum of λ and λg,
the first pitch is a pitch between the feed antenna and the first parasitic antenna,
the second pitch is a pitch between the feed antenna and the second parasitic antenna,
the first length is a length of the phase adjustment line of the first parasitic antenna, and
the second length is a pitch between the feed antenna and the second parasitic antenna.

6. The antenna unit according to claim 4,
wherein the first pitch is different from the second pitch,
the first length is different from the second length,
a sum of the first pitch and the first length and a sum of the second pitch and the second length are substantially equal to each other.

7. The antenna unit according to claim 5,
wherein the first pitch is different from the second pitch,
the first length is different from the second length,
a sum of the first pitch and the first length and a sum of the second pitch and the second length are substantially equal to each other.
